(19) United States
(12) Patent Application Publication
(10) Pub. No.: US 2008/0120315 A1
(43) Pub. Date: May 22, 2008

(54) SIGNAL MESSAGE DECOMPRESSOR

(75) Inventors: Catalin Ionescu, Tampere (FI); Miraj Mostafa, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/562,096

(22) Filed: Nov. 21, 2006

(51) Int. Cl. G06F 17/00

(52) U.S. Cl. 707/101

(57) ABSTRACT

A method for compressing data comprising, selecting a dictionary, compressing data using the dictionary, and appending an indicator to the compressed data, wherein the indicator comprises an indicator value representing the dictionary. A compression algorithm may also be defined, wherein the compressing of data comprises compressing data using the selected compression algorithm and dictionary, and wherein the first indicator further comprises a second indicator value representing the compression algorithm.

### FIELD OF THE INVENTION

The present invention relates to a method for compressing data, and in particular, a method for compressing data in signal messages within communication sessions.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A communication system can be seen as a facility that enables communication sessions between two or more entities such as user equipment and/or other nodes associated with the communication system. The communication may comprise, for example, communication of voice, data, multimedia and so on. A user equipment may, for example, be provided with a two-way telephone call or multi-way conference call. A user equipment may also be provided with a connection to an application providing entity, for example to an application server (AS), thus enabling use of services provided by the application server.

A communication system typically operates in accordance with a given standard or specification which sets out what the various entities associated with the communication system are permitted to do and how that should be achieved. For example, the standard or specification may define if the user, or more precisely, user equipment is provided with a circuit switched service and/or a packet switched service. Communication protocols and/or parameters which shall be used for the connection may also be defined. In other words, a specific set of “rules” on which the communication can be based on needs to be defined to enable communication by the system.

Data transmission and storage requires the use of resources such as bandwidth and storage capacity. One method which can be used to reduce the use of such bandwidth is by performing a signal compression on the data prior to transmission/storage whereby the data is reduced in size either by a compression algorithm that retains all of the information within the data being compressed allowing the data to be fully restored (i.e. a lossless compression system). An alternative method performs signal compression by removing low value information from the data being compressed allowing the data to be restored with some error value (i.e. a lossy compression system).

One known method for performing lossless compression relies on the use of a dictionary. The dictionary is a data structure containing a string of tokens or characters. The compressor searches the dictionary to find a match for a part of the data to be compressed within the dictionary and replaces any match with the position and length of the matched token in the dictionary.

Typically dictionaries used in communication systems are known as dynamic dictionaries. These dictionaries are created by the compressor by analyzing the data to be compressed element by element and identifying common tokens/character strings. They have been preferred used as it is possible to use the decompressed message as its own dictionary at the decompressor, thus avoiding the requirement to store or transmit the dictionary as a separate data file.

One such use of signal compression/decompression is in communication systems providing wireless communication for user equipment. An example of the wireless systems is the public land mobile network (PLMN). Another example is a mobile communication system that is based, at least partially, on use of communication satellites. Wireless communications may also be provided by other arrangements, such as by wireless local area networks (WLAN). Communication on the wireless interface between the user equipment and the elements of the communication network can be based on an appropriate communication protocol. The operation of the station apparatus of the communication system and other apparatus required for the communication can be controlled by one or several control entities. The various control entities may be interconnected. One or more gateway nodes may also be provided for connecting a communication network to other networks. For example, a mobile network may be connected to communication networks such as an IP (Internet Protocol) and/or other packet switched data networks.

An example of the services that may be offered for users of a communication system is the so called multimedia services. An example of the communication systems enabled to offer multimedia services is the Internet Protocol (IP) Multimedia network. IP Multimedia (IM) functionalities can be provided by a IP Multimedia Core Network (CN) subsystem, or briefly IP Multimedia subsystem (IMS). The IMS includes various network entities for the provision of the multimedia services.

The Third Generation Partnership Project (3GPP) has defined use of the General Packet Radio Service (GPRS) as a backbone communication system for the provision of the IMS services, the GPRS being given herein as a non-limiting example of a possible backbone communication system enabling the multimedia services. The Third Generation Partnership Project (3GPP) has also defined a reference architecture for the third generation (3G) core network which will provide the users of user equipment with access to the multimedia services. This core network is divided into three principal domains. These are the Circuit Switched (CS) domain, the Packet Switched (PS) domain and the Internet Protocol Multimedia (IM) domain.

The latter of these, the TM domain, is for ensuring that multimedia services are adequately managed. The 3G IM domain supports the Session Initiation Protocol (SIP) as developed by the Internet Engineering Task Force (IETF). Session Initiation Protocol (SIP) is an application-layer control protocol for creating, modifying and terminating sessions with one or more participants (endpoints).

Before a user equipment is able to communicate with an IM CN subsystem, a GPRS attach procedure must be performed and a communication channel known as Packet Data Protocol (PDP) context for SIP signaling must be established. Furthermore once a communication channel is established other data protocols may be used to communicate data such as Hyper Text Transfer Protocol (HTTP).

With low-rate IP connectivity, transmission delays are significant. Call setup and feature invocation are adversely affected by retransmissions and multiple messaging, as required in some flows. SigComp protocols provide a solution to this problem by offering robust, lossless compression of application messages. Due to the heavy signalling involved and SIP, being a text based protocol, 3GPP IMS Release 5 standards mandates SigComp (Signalling Compression). Similarly HTTP data transferred over similar channels would also benefit from the application of SigComp protocols.

Once a device is in receipt of a SigComp compressed message or a message to compress an uncompressed message using the SigComp protocols, the device initializes an instance of a virtual machine (UDVM) for compressing/decompressing the message. The invoked UDVM uses dictionaries to compress the data and then a similar UDVM at the receiving end uses similar dictionaries to decompress the compressed message to reform the original message. An example of a dynamic dictionary is one formed by the SIP deflate algorithm using the LZ77 algorithm.

Static dictionaries are also known and also used in SigComp protocols. However static dictionary use is limited and problematic as they have to be synchronized between compressor and decompressor. One way the dictionaries are synchronized is to transfer the static dictionary together with the data (message). This may be acceptable for long messages where the compression benefit exceeds the bandwidth consumed by transmitting the dictionary (but not in terms of the SIP messages which are typically small).

Another solution is to have a static dictionary manager which dynamically manages the static dictionaries to maintain synchronisation between the compression and decompression stages. This approach is inefficient as it requires signalling overhead between the compressor and decompressor or between compressor/decompressor and central static dictionary store in order to maintain synchronisation of dictionaries.

Another solution is to predefine a standard static dictionary which is used between communication points. This solution however has problems in that in the standard static dictionary is typically either small and quick to use (i.e. can only produce a limited compression ratio) or is large and slow (i.e. the compression benefit is large but so is the computational and speed cost).

Although small specialized static dictionaries can produce large compression benefit for specialized purposes this produces a system where in order to compress/decompress a message of a general nature multiple small static dictionaries are loaded into the compressor/decompressor which have the same drawback of a single large static dictionary.

### SUMMARY OF THE INVENTION

Embodiments of the present invention aim to at least partially address the above problems. There is provided, according various embodiments of the present invention, a method for compressing data comprising: selecting a dictionary; compressing data using the dictionary; appending a first indicator to the compressed data, wherein the first indicator comprises a first indicator value representing the dictionary.

Embodiments of the invention as described above have the advantage that the compressor is able to provide an indicator where the indicator value can assist in the selection of a specific dictionary in any decompression operation. Thus the decompression operation can be optimised to use specific dictionaries allowing faster decompression or requiring less process memory as only indicated dictionaries are required to be used in the decompression procedure.

The method for compressing data described above may further comprise: selecting a compression algorithm; wherein compressing data comprises compressing data using the selected compression algorithm and dictionary; and wherein the first indicator further comprises a second indicator value representing the compression algorithm.

Therefore embodiments of the invention described above use the compressor to provide an indicator where the indicator value can assist in the selection of a decompression algorithm in the decompression operation. Thus the decompression operation can in embodiments be optimised to use specific algorithms requiring less process memory as only indicated algorithms are required to be used in the decompression procedure.

The method for compressing data described above may further comprise: receiving further data comprising a second indicator comprising a first indicator value; selecting the dictionary dependent on the second indicator's first indicator value.

Therefore embodiments of the invention described above may be further optimised so that the compression operation selects only dictionaries indicated to be present in a potential decompression device carrying out a decompression process. Thus in any embodiments of the above, there are fewer compression-decompression cycle errors where the compression process uses a dictionary not found by the decompression process.

The second indicator may further comprise a second indicator value, and the method may further comprise selecting the compression algorithm dependent on the second indicator's second indicator value.

Thus embodiments of the invention described above may be further optimised so that the compression operation selects only algorithms indicated to be present in a potential decompression device carrying out a decompression process. Thus in any embodiments of the above there are fewer compression-decompression cycle errors where the compression process uses a compression algorithm not found by the decompression process.

The second indicator may be appended to a header of the further data. The first indicator may be appended to a header of the compressed data.

The method for compressing data as describes above further comprising: transmitting the compressed data and the first indicator.

According to a second aspect of the present invention there is provided a compressor comprising: a processor arranged to receive data; to select a dictionary, and to compress the data using the dictionary to output compressed data; wherein the processor is further arranged to append to the compressed data a first indicator comprising a first indicator value representing the dictionary.

The processor may be further arranged to select a compression algorithm; wherein the processor is arranged to compress the data using the selected compression algorithm and dictionary to output compressed data; and wherein the first indicator further comprises a second indicator value representing the compression algorithm. The processor may be arranged to receive further data comprising a second indicator; and to select the dictionary dependent on a first value of the second indicator. The processor may also arranged to select the compression algorithm dependent on the second value of the second indicator.

The second indicator may be appended to a header of the further data. The first indicator may be appended to a header of the compressed data. Additionally, the dictionary may be a static dictionary.

According to a third aspect of the present invention there is provided a method for decompressing data comprising: receiving a data block comprising a first indicator and a compressed data; wherein the first indicator comprises a first indicator value selecting at least one dictionary dependent on the first indicator value; and performing the decompression of the compressed data using the dictionary.

The first indicator may further comprise a second indicator value; and the method may further comprise: selecting a decompression algorithm dependent on the second indicator value of the first indicator; and performing the decompression of the compressed data comprises decompressing data using the selected decompression algorithm and dictionary.

The method for decompressing data as described above may further comprise: determining an available dictionary; selecting a first indicator value for a second indicator to represent the available dictionary; and transmitting the first indicator value of the second indicator to represent the available dictionary.

The method for decompressing data as described above may further comprise: determining an available decompression algorithm; selecting a second indicator value for the second indicator to represent the available decompression algorithm; and transmitting the second indicator value of the second indicator to represent the available decompression algorithm.

The second indicator may be appended to a header of further data.

The first indicator may be appended to a header of the data block.

According to a fourth aspect of the present invention there is provided a decompressor, comprising: a processor arranged to select a dictionary dependent on a first indicator value of a first indicator and further arranged to decompress the data using the dictionary.

The first indicator may further comprise a second indicator value; wherein the processor is further arranged to select a decompression algorithm dependent on the second indicator value; and perform the decompression of the compressed data using the selected decompression algorithm and dictionary.

The decompressor described above may further comprise a memory and wherein the processor may be arranged to detect at least one dictionary within the memory, to select a first indicator value of a second indicator to represent the at least one dictionary, and to transmit the first indicator value of the second indicator to represent the at least one dictionary.

The processor may be arranged to detect at least one decompression algorithm within the memory, to select a second indicator value of the second indicator to represent the at least one decompression algorithm, and to transmit the second indicator value of the second indicator to represent the at least one decompression algorithm.

The second indicator may be appended to a header of further data, and the first indicator may be appended to a header of the data block.

According to a fifth aspect of the present invention there is provided a system comprising a compressor comprising: a processor arranged to receive data; to select a dictionary, and to compress the data using the dictionary to output compressed data; wherein the processor is further arranged to append to the compressed data a first indicator comprising a first indicator value representing the dictionary; and a decompressor comprising: a processor arranged to receive a data block comprising the first indicator; to select a dictionary dependent on the first indicator value of the first indicator and further arranged to decompress the data using the dictionary.

According to a sixth aspect of the present invention there is provided apparatus for compressing data comprising: means arranged to receive data; to select a dictionary, and to compress the data using the dictionary to output compressed data; wherein the means is further arranged to append to the compressed data a first indicator comprising a first indicator value representing the dictionary.

According to a seventh aspect of the present invention there is provided apparatus for decompressing data comprising: means arranged to receive a data block comprising a first indicator and compressed data; wherein the first indicator comprises a first indicator value; wherein the means is further arranged to select a dictionary dependent on the first indicator value and further arranged to decompress the data using the dictionary.

According to an eighth aspect of the present invention there is provided a computer program product arranged to perform a method for compressing data comprising: selecting a dictionary; compressing data using the dictionary; appending a first indicator to the compressed data, wherein the first indicator comprises a first indicator value representing the dictionary.

The computer program product as described above may be further arranged to perform a method for compressing data further comprising: selecting a compression algorithm; wherein compressing data comprises compressing data using the selected compression algorithm and dictionary; and wherein the first indicator further comprises a second indicator value representing the compression algorithm.

The computer program product as described above may be further arranged to perform a method, further comprising selecting the dictionary dependent on the first value of the second indicator.

The computer program product as described above may be further arranged to perform a method, further comprising: receiving further data comprising a second indicator; and selecting the compression algorithm dependent on the second value of the second indicator.

According to a ninth aspect of the present invention there is provided a computer program product arranged to perform a method for decompressing data comprising: receiving a data block comprising a first indicator and compressed data; wherein the first indicator comprises a first indicator value; selecting at least one dictionary dependent on the first indicator value of the first indicator; and performing the decompression of the compressed data using the dictionary.

The computer program product arranged to perform a method for decompressing data as described above may comprise the first indicator may further comprise a second indicator value; and the method may further comprise: selecting a decompression algorithm dependent on the second indicator value of the first indicator; and wherein performing the decompression of the compressed data comprises decompressing data using the selected decompression algorithm and dictionary.

The computer program product arranged to perform a method for decompressing data as described above may further comprise determining an available dictionary; selecting a second indicator first indicator value to represent the available dictionary; and transmitting the first indicator value of the second indicator to represent the available dictionary.

The computer program product arranged to perform a method for decompressing data as described above may further comprise: determining an available decompression algorithm; selecting a second indicator second indicator value to represent the available decompression algorithm; and transmitting the second indicator value of the second indicator to represent the available decompression algorithm.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

For better understanding of the present invention, reference will now be made by way of example to the accompanying drawings in which:

FIG. 1 shows a schematic view of a communication system environment wherein embodiments of the present invention can be embodied;

FIG. 2 shows a schematic view of a device within a communications system in accordance with an embodiment of the present invention;

FIG. 3(a) shows a schematic view of a pair of devices in accordance with embodiments of the present invention;

FIG. 3(b) shows a flow diagram showing the operation of a first embodiment of the present invention for a compression and decompression operation;

FIG. 4 shows a flow diagram for the operation of a second embodiment of the present invention for a compression and decompression operation; and

FIG. 5 shows a flow diagram for the operation of further embodiment of the present invention for a compression and decompression operation.

### DETAILED DESCRIPTION OF VARIOUS EMBODIMENTS

Certain embodiments of the present invention will be described in the following by way of example, with reference to the exemplifying architecture of a third generation (3G) mobile communications system. However, it shall be appreciated that the embodiments may be applied to any suitable communication system. Furthermore although the examples as described below refer to a compression operation and specifically to a DEFLATE algorithm variant of a SigComp compression algorithm, it shall be appreciated that the embodiments may be applied to any suitable compression/decompression algorithm where static dictionaries can be used.

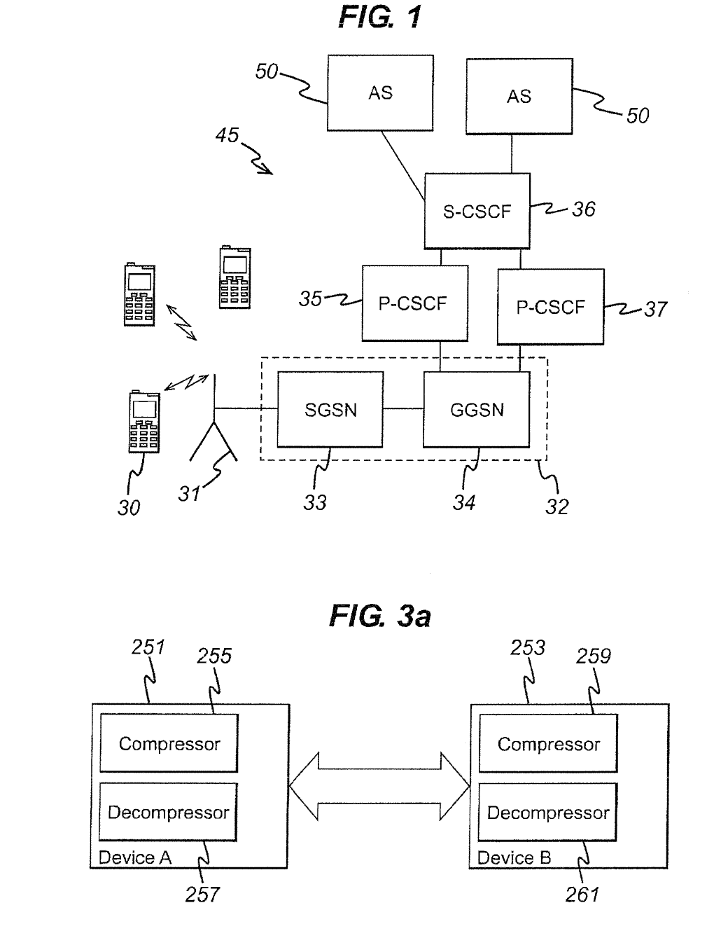

Reference is made to FIG. 1 which shows an example of a network architecture wherein embodiments of the invention may be embodied. In FIG. 1 an IP Multimedia Network 45 is provided for offering IP multimedia services for IP Multimedia Network subscribers.

As described above, access to IP Multimedia (IM) services can be provided by a mobile communication system. A mobile communication system is typically arranged to serve a plurality of mobile user equipment usually via a wireless interface between the user equipment and at least one base station 31 of the communication system. The mobile communication system may logically be divided between a radio access network (RAN) and a core network (CN).

The base station 31 is arranged to transmit signals to and receive signals from a mobile user equipment 30 via a wireless interface between the user equipment and the radio access network. Correspondingly, the mobile user equipment 30 is able to transmit signals to and receive signals from the radio access network via the wireless interface.

In the shown arrangement the user equipment 30 may access the IMS network 45 via the access network associated with the base station 31. It shall be appreciated that, although, for clarity reasons FIG. 1 shows a base station of only one radio access network, a typical communication network system usually includes a number of radio access networks.

The 3G radio access network (RAN) is typically controlled by appropriate radio network controller (RNC). This controller is not shown in order to enhance clarity. A controller may be assigned for each base station or a controller can control a plurality of base stations, for example in the radio access network level. It shall be appreciated that the name, location and number of the radio network controllers depends on the system.

The mobile user equipment 30 of FIG. 1 may comprise any appropriate mobile user equipment adapted for Internet Protocol (IP) communication to connect the network. For example, the mobile user may access the cellular network by a Personal computer (PC), Personal Data Assistant (PDA), mobile station (MS) and so on. The following examples are described with reference to mobile stations.

One skilled in the art is familiar with the features and operation of a typical mobile station. Thus, it is sufficient to note that the user may use a mobile station for tasks such as for making and receiving phone calls, for receiving and sending data from and to the network and for experiencing multimedia content or otherwise using multimedia services. A mobile station may include an antenna for wirelessly receiving and transmitting signals from and to base stations of the mobile communication network. A mobile station may also be provided with a display for displaying images and other graphical information for the user of the mobile user equipment. A camera may be provided for capturing still or video images. Speakers may also be provided. The operation of a mobile station may be controlled by an appropriate user interface such as control buttons, voice commands and so on. Furthermore, a mobile station is provided with a processor entity and a memory.

It shall be appreciated that although only few mobile stations are shown in FIG. 1 for clarity, a great number of mobile stations may be in simultaneous communication with a communication system.

A core network (CN) typically includes various switching and other control entities and gateways for enabling the communication via a number of radio access networks and also for interfacing a single communication system with one or more communication systems such as with other cellular systems and/or fixed line communication systems. In the 3GPP systems the radio access network is typically connected to an appropriate core network entity or entities such as, but not limited to, a serving general packet radio service support node (SGSN) 33. The radio access network is in communication with the serving GPRS support node via an appropriate interface, for example on an Iu interface. The serving GPRS support node, in turn, typically communicates with an appropriate gateway, for example a gateway GPRS support node 34 via the GPRS backbone network 32. This interface is commonly a switched packet data interface.

In a 3GPP network, a packet data session is established to carry traffic flows over the network. Such a packet data session is often referred as a packet data protocol (PDP) context. A PDP context may include a radio bearer provided between the user equipment and the radio network controller, a radio access bearer provided between the user equipment, the radio network controller and the SGSN 33, and switched packet data channels provided between the serving GPRS service node 33 and the gateway GPRS service node 34. Each PDP context usually provides a communication pathway between a particular user equipment and the gateway GPRS support node and, once established, can typically carry multiple flows. Each flow normally represents, for example, a particular service and/or a media component of a particular service. The PDP context therefore often represents a logical communication pathway for one or more flows across the network. To implement the PDP context between user equipment and the serving GPRS support node, at least one radio access bearer (RAB) needs to be established which commonly allows for data transfer for the user equipment. The implementation of these logical and physical channels is known to those skilled in the art and is therefore not discussed further herein.

FIG. 1 shows also a plurality of application servers 50 connected to the exemplifying Internet Protocol (IP) Multimedia network 45. The user equipment 30 may connect, via the GPRS network 32 and an IMS network 45, to at least one of the application servers 50. It shall be appreciated that a great number of application servers may be connected to a data network.

Communication with the application servers is controlled by functions of the data network that are provided by appropriate controller entities. For example, in the current third generation (3G) wireless multimedia network architectures it is assumed that several different servers providing various control functions are used for the control. These include functions such as the call session or call state control functions (CSCFs). The call session functions may be divided into various categories. FIG. 1 shows proxy call session control functions (P-CSCF) 35 and 37 and a serving call session control function (S-CSCF) 36. It shall be appreciated that similar functions may be referred to in different systems with different names.

A user who wishes to use services provided by an application server via the IMS system may need first to register with a serving controller, such as the serving call session control function (S-CSCF) 36. The registration is required to enable the user equipment to request a service from the multimedia system. As shown in FIG. 1, communication between the S-CSCF 36 and the user equipment 30 may be routed via at least one proxy call session control function (P-CSCF) 35. The proxy CSCF 35 thus acts as a proxy which forwards messages from the GGSN 34 to a serving call session control function 36 and vice versa.

The embodiments of the invention described hereafter feature the example of a REGISTER SIP message. The REGISTER message used by the user above is one example of a SIP (session initiation protocol) message. However embodiments of the invention may be used in compression/decompression of other SIP messages and request SIP messages. A non-exhaustive list of SIP messages includes, INVITE which indicates a user or service is being invited to participate in a call session, ACK which confirms that the client has received a final response to an INVITE request, BYE which terminates a call and can be sent by either the caller or the callee, CANCEL which cancels any pending searches but does not terminate a call that has already been accepted, and OPTIONS which queries the capabilities of servers.

As has been described earlier it is known to compress these SIP messages using the protocol set known as SigComp. This protocol set is defined in RFC (request for comments) 3320 “Signalling Compression (SigComp)”. Compression within the device is performed by a compressor. Decompression as defined by the standard is performed within a device following the initiation of a UDVM (universal decompression virtual machine) for each message to be decompressed.

Within the compressor the memory space used by a compression procedure is known as the compression memory.

The typical compression algorithms used by the UDVM for SigComp protocol messages and data streams are the various known LZ77 compression algorithm variants. The LZ77 compression algorithm works by storing a history window of the most recently read data and comparing the current data being encoded with the data in the history window. The output compressed stream/message contains references to the position in the history window, and the length of the match. If a match cannot be found within the history window the character itself is simply encoded into the stream and flagged as a ‘literal’. The compressed stream/message therefore comprises two types of symbols, literals and length/position pairs. The most popular variants of the algorithm family are the LZW, LZSS and DEFLATE algorithms. The differences between these lies in the algorithm used to search current data from the history window, the LZSS algorithm uses a simple binary tree search whereas the DEFLATE algorithm uses a hash table search. For the examples detailed below the DEFLATE algorithm and a bytecode implementation of the DEFLATE algorithm are described. However the principles of the invention as described hereafter can be applied to any implementation of the DEFLATE algorithm and/or other SigComp bytecode.

A UDVM initiated for a decompression procedure is also known as a decompressor. The UDVM on initiation is defined within a memory space specified by the SigComp protocols. The memory space used in a decompression procedure is known as a decompression space.

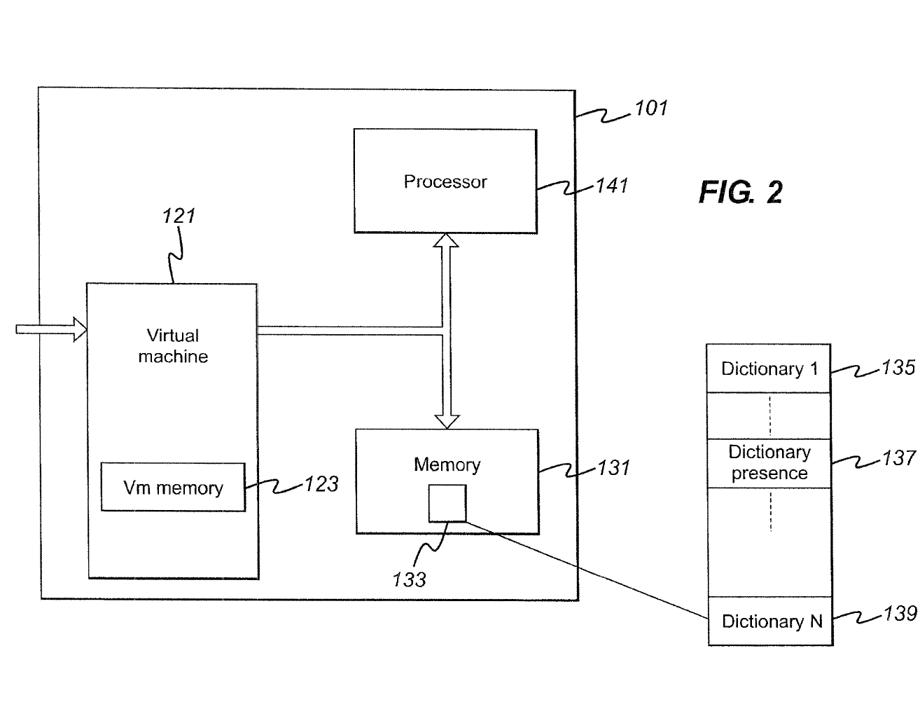

With reference to FIG. 2 a simplified device capable of operating embodiments of the invention is shown. The device 101 comprises a native code processor 141, a memory 131 and a virtual machine 121. The native code processor receives and processes device specific code. The virtual machine 121 receives virtual machine code, also known as bytecode, (Bytecode is computer object code that is processed by the virtual machine, rather than by the “real” device, the hardware processor. The virtual machine converts each generalized machine instruction into a specific machine instruction or instructions that the device's processor will understand. These specific machine instructions are also known as native code.) and outputs device specific code to the processor.

The memory 131 connected to both the native code processor 141 and the virtual machine 121 stores data which can be used by both the native code processor 141 and the virtual machine 121. The memory 131 comprises a series (N+1) of known dictionaries 133, for example dictionary 1 135 to dictionary N 139, including a presence dictionary 137. Each dictionary is arranged to be associated with a specific function or operator or service type. For example the presence dictionary 137 is associated with producing significant compression ratios or benefits when compressing presence data.

In some embodiments of the present invention the virtual machine 121 is implemented in software running on the native code processor 141. In other embodiments of the present invention the virtual machine 121 is implemented in software running on a co-processor (not shown) or implemented in hardware (not shown) separate from the native code processor 141.

The virtual machine 121 comprises a code converter (or as also known a virtual machine interpreter). The code converter receives the bytecode and converts it to the device specific code which it outputs to the processor 141. The virtual machine 121 further comprises a virtual machine memory space 123. The virtual machine memory space represents the memory units used by the virtual machine 121. The virtual machine memory space may represent memory units within the memory 131 or memory units within a memory not shown (for example a memory cache on the processor).

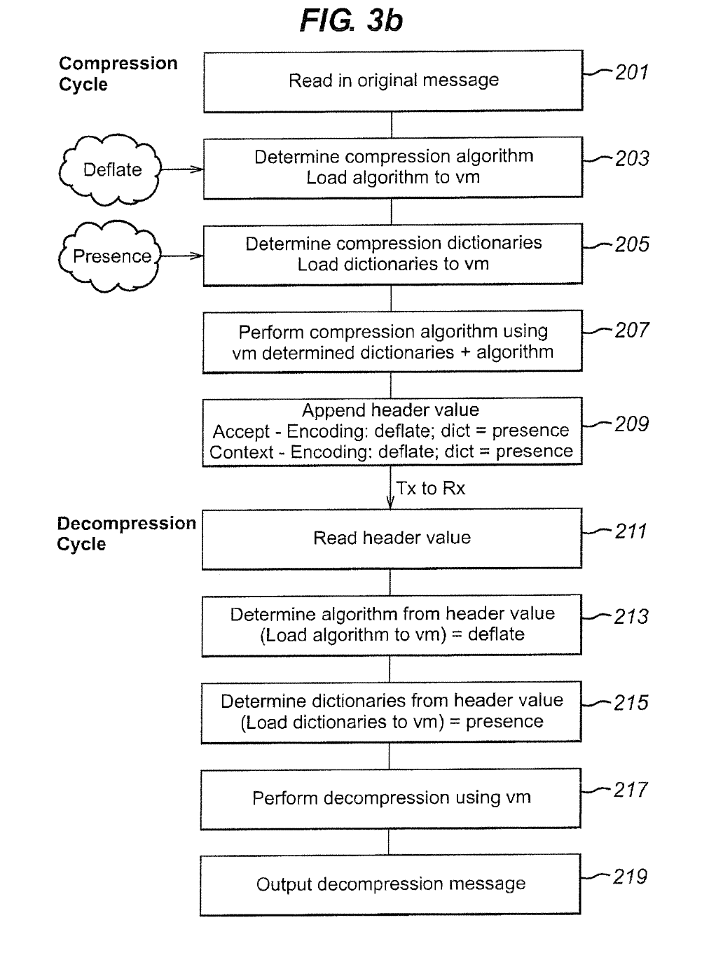

With reference to FIGS. 3(a) and 3(b) a first embodiment of the present invention is shown during the compression and decompression cycle between two devices 251 and 253 as shown in FIG. 3(a). FIG. 3(a) shows device A 251 with a compressor 255 and a decompressor 257, and device B 253 with a compressor 259 and decompressor 261. FIG. 3(b) shows a compression/decompression cycle for the first embodiment of the invention. The compression cycle spans from receipt of the original message in device A 251 to the transmission of the compressed message to device B 253, represented at 201 to 209. The decompression cycle spans from receiving the compressed message at device B 253 to outputting the decompressed message, represented at 211 to 219.

At 201 the original message is read into the compressor 255 of device A 251.

At 203 the compressor 255 determines the compression algorithm, in this example the DEFLATE algorithm. The compressor 255 then assigns or loads the deflate algorithm from a memory to the compressor 255.

At 205, the compressor 255 determines which static compression dictionaries are to be used. In this example the presence dictionary is determined as the message to be compressed is presence based.

At 207, the compressor 255 performs the compression algorithm using the determined dictionaries and algorithms. This process is known in the art and discussed in detail in request for comments (RFC) standards 3320 and 3321.

At 209, the compressor 255, prior to transmitting the compressed message by the device 251, the compressor appends the header value with an indicator which identifies which, if any, static dictionaries have been applied during the compression algorithm. In a first embodiment of the invention the header value is appended to be the following:

CONTENT-ENCODING:deflate; dict=presence

The header indicates to the remote decompressor 261, in other words the decoder of device B, that the message has been encoded using the deflate algorithm and also using the presence static dictionary. In other embodiments of the present invention it would be understood that other dictionaries and other compression algorithms can be encoded and indicated to the remote decoder 261 using similar headers.

At 211 device B 253, receives the encoded message and reads the appended header value. The message is passed to device B decoder 261 for processing.

The decompressor 261 of device B 253 at 213 is able to determine the encoding algorithm and dictionaries used from the header value. In this example the algorithm is the deflate algorithm. The processor of the receiver device then loads the virtual machine of the receiver device with the deflate algorithm.

In some embodiments of the present invention if the decoder 261 is unable to accept the encoded message, for example if the decoder determines that the decoding algorithm or static dictionary is not present in device B, then device B 253 transmits an error message to device A 251.

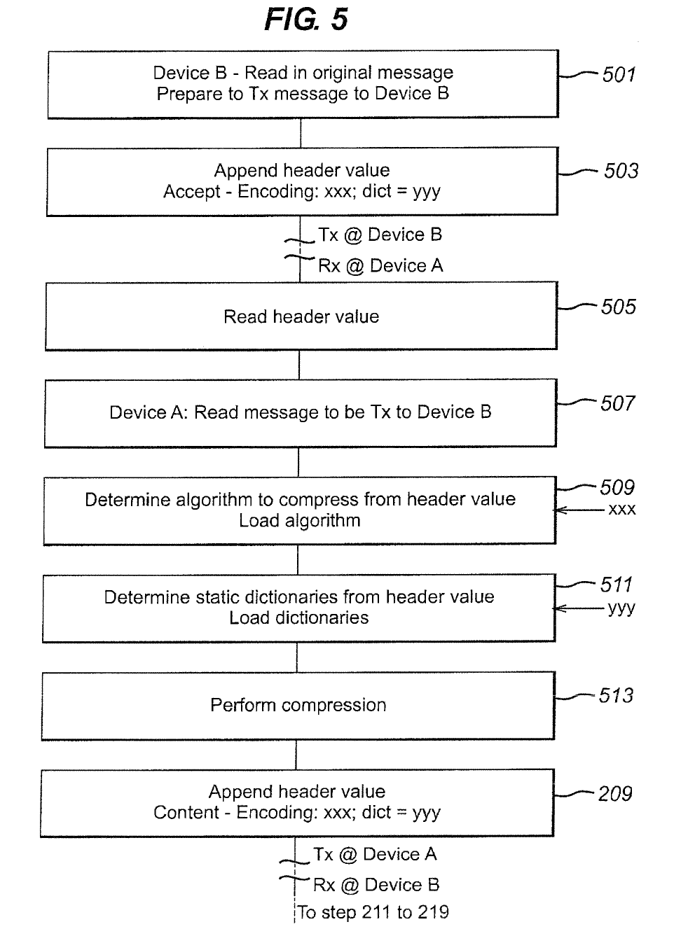

In some embodiments of the present invention this error message contains the “accept” header data described below with reference to FIG. 5.

In other embodiments of the present invention the decoder 261, on detecting an error, proceeds to request the missing decryption algorithm or static dictionary from either device A 251 or from a network element (not shown).

However if the receiver is able to accept the encoded message then the process passes to process 215.

At 215, the decoder 261 of device B 253 determines the dictionaries required from the header values of the received compressed message. In this case the dictionary used is the presence dictionary. The presence dictionary is in this example loaded into the decoder virtual machine of the device.

At 217, the decoder virtual machine performs the required decompression steps using the deflate algorithm and the presence dictionaries which have been loaded into the decoder virtual machine of device B 253 to produce the decompressed message. The resultant decompressed message is an exact copy of the original message data where lossless compression is used.

At 219, the decompressed message is output from the decompressor virtual machine.

The above method produces a clear improvement over the prior art enabling the device B to determine what compression algorithm and dictionary has been used and thus optimising the decompression cycle as the decompressor only is required to load and search through the indicated dictionaries and load and process using indicated algorithms.

A further embodiment of the invention further improves this process. FIG. 5 shows this further embodiment of the invention.

In the example shown in FIG. 5, process 501, occurs when device B 253 prepares to transmit a first message to device A 251. In the example described hereafter the message is compressed by device B 253 compressor 259. The processes followed are those similar to 201 to 209, but are performed in device B 253 compressor 259 rather than device A 251 compressor 255. The process then passes to 503.

However in some embodiments of the invention the message to be transmitted from device B to device A is not compressed, in which case the message is prepared for transmission prior to carrying out 503.

At 503, device B appends the header with the following value

ACCEPT-ENCODING:deflate; dict=presence

The header provides an indication to device A as to which algorithms and which dictionaries the device B decompressor 261 is capable of processing. In the example above the device B has indicated that the decompressor 261 is able to accept compressed data which has been compressed using the deflate algorithm and the static presence dictionary. For simplicity just one compression algorithm and one dictionary are shown in the example above. It should be noted that the header can comprise indication (e.g. a list) of several compression algorithms and dictionaries.

In FIG. 5 the term ‘xxx’ refers to the algorithm or algorithms that the decompressor can accept and the term ‘yyy’ refers to the dictionary or dictionaries that the decompressor has access to.

At 505 the message is received by device A. This message can be decompressed in a manner shown at 211 to 219 using the “content” header information inserted at 501 to enable device A 251 decompressor 257 to efficiently process compressed message. Furthermore the data or information associated with the “accept” header appended At 503 is also received by device A and is stored for later use.

507 to 515 in this example show how this information can be used to improve on the embodiment described with reference to FIG. 3(b). These are similar to 201 to 209.

At 507, which is similar to 201 of FIG. 3(b), a message to be transmitted to device B 253 is read into the compressor 255 of device A 251.

At 509, which is similar to 203 of FIG. 3(b), the compressor 255 determines a compression algorithm to be used on the message. However in contrast with the determination process 203, 509 also uses the information provided by the “accept” header part to determine an algorithm which is known to both device A and device B. Furthermore this algorithm is loaded into the compressor 255. For example where the “accept” header indicated that the device B is able to decompress deflate compressed message the compressor 255 is loaded with the deflate algorithm.

At 511, which is similar to 205 of FIG. 3(b), the compressor 255 determines at least one static dictionary to be used in the compression of the message. The difference between 511 and 205 is that 511 uses the information provided in the “accept” header part to determine at least one static dictionary which is known to both devices. Furthermore the detected dictionary is loaded into the compressor 255. For example where the “accept” header indicated that the device B has access to the presence dictionary as indicated by example above the presence dictionary is selected and loaded into the compressor.

At 513, which is similar to 207 of FIG. 3(b), the compressor 255 carries out the compression using the loaded algorithms and dictionaries.

At 515, which is similar to 209 of FIG. 3(b), the compressor 255 appends a “content” header to the compressed message as previously discussed At 209 of FIG. 3(b).

It would be appreciated that the following decompression cycle would be similar to 211 to 219. However as the compression cycle was carried out with the information of which algorithms and dictionaries were present in the decompressor then the possibility of an error in the decompression cycle of incompatible algorithms or dictionaries is practically eliminated.

Thus the above embodiments of the invention enable both the compression cycle and more significantly the decompression device to load optimized dictionaries for the specific compression purpose and therefore produce not only significant compression ratios but also significant speed benefit over the more general dictionaries.

In some embodiments of the present invention the value of the “dict” parameter which indicates which dictionary is being used can be a uniform resource identifier (URI) or a multi-purpose Internet mail extension (MIME) in order to distinguish between different dictionaries. Furthermore the indicators may distinguish between different types of presence dictionaries defined by various different entities for example by the IETF, Vodafone, Nokia for example.

Other dictionaries would have corresponding values, for example the use of a SIP dictionary may have the value dict=SIP.

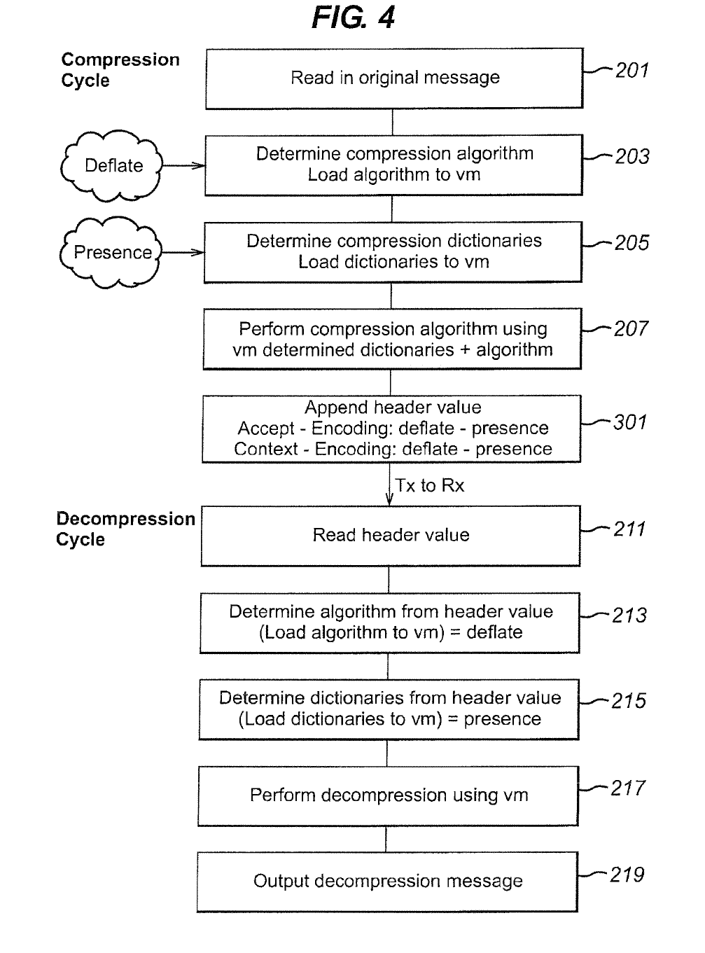

With respect to FIG. 4 further alternative embodiments of the present invention are shown. The method shown in FIG. 4 is similar to that shown in FIG. 3(b) and FIG. 5. For example the header value(s) appended to the compressed message are one or both of at least

ACCEPT-ENCODING:deflate−presence;

CONTENT-ENCODING:deflate−presence

which indicates that the encoding method used or can be used in an encoded message is the deflate algorithm using the presence dictionary by a compound field of “algorithm-dictionary”, where the first part of the field indicates the algorithm used (or acceptable to use) and the second part the static dictionary or dictionaries used (or acceptable to use).

In some embodiments of the present invention compression and decompression is carried out by operation of hardware or software in a data processor or a combination of the two without using virtual machines. In such embodiments the compression and decompression parts can by limiting the size of the dictionaries used by the data processor produce the same benefits as the processor can load the dictionaries into fast access memory (such as cache memory). Furthermore other advantages of embodiments of the present invention allow the algorithms to be run on cheaper or less powerful processors, i.e. in processors with smaller onboard memory or with smaller cache memories.

In some embodiments of the present invention compression can be carried out in two stages, the first using the embodiment as described above and secondly using a conventional SigComp protocol. In such embodiments where SigComp is carried out the processor in some embodiments of the present invention does not carry out a first compression stage.

Furthermore in some embodiments of the invention the compression algorithm only compresses the body and retains the original header of the original message.

Furthermore although the above embodiments discuss the use of the deflate algorithm, the deflate algorithm is not the only compression algorithm that uses static dictionaries. Thus embodiments of the present invention are applicable to other compression schemes using static dictionaries, for example Wireless Binary XML compressed message with indicators attached to the header of the compressed WB-XML code message can be used by the receiver of the WB-XML message to decompress the message using the indicated dictionaries.

In further embodiments of the present invention the receiver device on determination of a specific dictionary not being in the memory of the receiver is capable of receiving the required dictionary from a third party source or from the transmitter device.

The examples of the invention have been described in the context of an IMS system and GPRS networks. However, this invention is also applicable to any other standards. Furthermore, the given examples are described in the context of the so called all SIP networks with all SIP entities and communication channels known as PDP contexts. This invention is also applicable to any other appropriate communication systems, either wireless or fixed line systems, communication standards and communication protocols.

Examples of other possible communication systems enabling wireless data communication services, without limiting to these, include third generation mobile communication system such as the Universal Mobile Telecommunication System (UMTS), i-phone or CDMA2000 and the Terrestrial Trunked Radio (TETRA) system, the Enhanced Data rate for GSM Evolution (EDGE) mobile data network. Other possible communication systems enabling wireless data communication services within which embodiments of the invention could be employed include those employing the WiMax (Worldwide Interoperability for Microwave Access) standards. These may be compliant with for example IEEE 802.16, HiPerman (High Performance Metropolitan Access Network), or WiBro (Wireless Broadband) standards. Further examples of possible communication systems enabling wireless data communication services within which embodiments of the invention could be employed include WLAN (Wireless Local Area Network) communication systems such as those using any of the IEEE 802.11 standards. Examples of fixed line systems include the diverse broadband techniques providing Internet access for users in different locations, such as at home and offices. Regardless the standards and protocols used for the communication network, the embodiments of invention can be applied in all communication networks wherein registration in a network entity is required.

The embodiment of the invention have been discussed in the context of proxy and servicing call state control functions. Embodiments of the invention can be applicable to other network elements where applicable.

The present invention is described in the general context of method steps, which may be implemented in one embodiment by a program product, embodied in a computer-readable medium, including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps. The program code product for providing the operation may be stored on and provided by a carrier medium such as a carrier disc, card, tape or other memory unit, and the code can be processed by a processor.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for compressing data comprising:
selecting a dictionary;
compressing data using the dictionary; and
appending a first indicator to the compressed data, wherein the first indicator comprises a first indicator value representing the dictionary.

2. A method for compressing data as claimed in claim 1, further comprising:
selecting a compression algorithm,
wherein the compressing of data comprises compressing data using the selected compression algorithm and dictionary, and wherein the first indicator further comprises a second indicator value representing the compression algorithm.

3. A method for compressing data as claimed in claim 2, further comprising:
receiving further data comprising a second indicator including a first indicator value;
selecting the dictionary dependent on the second indicator's first indicator value.

4. A method for compressing data as claimed in claim 3, wherein the second indicator further comprises a second indicator value, and further comprising:
selecting the compression algorithm dependent on the second indicator's second indicator value.

5. A method for compressing data as claimed in claim 3, wherein the second indicator is appended to a header of the further data.

6. A method for compressing data as claimed in claim 1, wherein the first indicator is appended to a header of the compressed data.

7. A method for compressing data as claimed in claim 1, further comprising:
transmitting the compressed data and the first indicator.

8. A compressor, comprising:
a processor arranged to receive data; to select a dictionary, and to compress the data using the dictionary to output compressed data;
wherein the processor is further arranged to append to the compressed data a first indicator comprising a first indicator value representing the dictionary.

9. A compressor as claimed in claim 8, wherein the processor is further arranged to select a compression algorithm, wherein the processor is arranged to compress the data using the selected compression algorithm and dictionary to output compressed data, and wherein the first indicator further comprises a second indicator value representing the compression algorithm.

10. A compressor as claimed in claim 9, wherein the processor is arranged to receive further data comprising a second indicator, and to select the dictionary dependent on a first value of the second indicator.

11. A compressor as claimed in claim 10,
wherein the processor is arranged to select the compression algorithm dependent on a second value of the second indicator.

12. A compressor as claimed in claim 10, wherein the second indicator is appended to a header of the further data.

13. A compressor as claimed in claim 8, wherein the first indicator is appended to a header of the compressed data.

14. A compressor as claimed in claim 8, wherein the dictionary is a static dictionary.

15. A method for decompressing data comprising:
receiving a data block comprising a first indicator and a compressed data; wherein the first indicator comprises a first indicator value;
selecting at least one dictionary dependent on the first indicator value; and
performing decompression of the compressed data using the dictionary.

16. A method for decompressing data as claimed in claim 15, wherein the first indicator further comprises a second indicator value; and the method further comprises:
selecting a decompression algorithm dependent on the second indicator value of the first indicator, and wherein the performing of the decompression of the compressed data comprises decompressing data using the selected decompression algorithm and dictionary.

17. A method for decompressing data as claimed in claim 15, further comprising:
determining an available dictionary;
selecting a first indicator value for a second indicator to represent the available dictionary; and
transmitting the first indicator value of the second indicator to represent the available dictionary.

18. A method for decompressing data as claimed in claim 17, further comprising:
determining an available decompression algorithm;
selecting a second indicator value for the second indicator to represent the available decompression algorithm; and
transmitting the second indicator value of the second indicator to represent the available decompression algorithm.

19. A method for decompressing data as claimed in claim 17, wherein the second indicator is appended to a header of further data.

20. A method for decompressing data as claimed in claim 15, wherein the first indicator is appended to a header of the data block.

21. A decompressor, comprising:
a processor arranged to select a dictionary dependent on a first indicator value of a first indicator and further arranged to decompress the data using the dictionary.

22. A decompressor as claimed in claim 21, wherein the first indicator further comprises a second indicator value; wherein the processor is further arranged to select a decompression algorithm dependent on the second indicator value; and
perform the decompression of the compressed data using the selected decompression algorithm and dictionary.

23. A decompressor as claimed in claim 21, further comprising a memory and wherein the processor is arranged to detect at least one dictionary within the memory, to select a first indicator value of a second indicator to represent the at least one dictionary, and transmit the first indicator value of the second indicator to represent the at least one dictionary.

24. A decompressor as claimed in claim 23, wherein the processor is arranged to detect at least one decompression algorithm within the memory, to select a second indicator value of the second indicator to represent the at least one decompression algorithm, and to transmit the second indicator value of the second indicator to represent the at least one decompression algorithm.

25. A decompressor as claimed in claim 23, wherein the second indicator is appended to a header of further data.

26. A decompressor as claimed in claim 21, wherein the first indicator is appended to a header of the data block.

27. A system including a compressor, comprising:
a processor configured to:
receive data,
select a dictionary,
compress the data using the dictionary to output compressed data, and
append to the compressed data a first indicator comprising a first indicator value representing the dictionary; and
a decompressor comprising a processor arranged to:
receive a data block comprising the first indicator
select a dictionary dependent on the first indicator value of the first indicator, and
decompress the data using the dictionary.

28. Apparatus for compressing data, comprising:
means for receiving data, selecting a dictionary, compressing the data using the dictionary to output compressed data,
wherein the means is further configured to append to the compressed data a first indicator comprising a first indicator value representing the dictionary.

29. Apparatus for decompressing data, comprising:
means for receiving a data block comprising a first indicator and compressed data, the first indicator including a first indicator value, wherein the means is further configured to select a dictionary dependent on the first indicator value and to decompress the data using the dictionary.

30. A computer program product, embodied in a computer-readable medium, for compressing data, comprising:
computer code for selecting a dictionary;
computer code for compressing data using the dictionary; and
computer code for appending a first indicator to the compressed data, wherein the first indicator comprises a first indicator value representing the dictionary.

31. A computer program product as claimed in claim 30, further comprising:
computer code for selecting a compression algorithm,
wherein the computer code for compressing data comprises code for compressing data using the selected compression algorithm and dictionary, and wherein the first indicator further comprises a second indicator value representing the compression algorithm.

32. A computer program product as claimed in claim 31, wherein the selecting of the dictionary is dependent on the first value of the second indicator.

33. A computer program product as claimed in claim 32, further comprising
computer code for receiving further data comprising a second indicator; and
computer code for selecting the compression algorithm dependent on the second value of the second indicator.

34. A computer program product, embodied in a computer readable medium, for decompressing data, comprising:
computer code for receiving a data block comprising a first indicator and compressed data; wherein the first indicator comprises a first indicator value
computer code for selecting at least one dictionary dependent on the first indicator value of the first indicator; and
computer code for performing the decompression of the compressed data using the dictionary.

35. A computer program product arranged to perform a method for decompressing data as claimed in claim 34, wherein the first indicator further comprising a second indicator value, and further comprising:
computer code for selecting a decompression algorithm dependent on the second indicator value of the first indicator, and wherein the computer code for performing the decompression of the compressed data comprises computer code for decompressing data using the selected decompression algorithm and dictionary.

36. A computer program product arranged to perform a method for decompressing data as claimed in claim 35, further comprising:
computer code for determining an available dictionary;
computer code for selecting a second indicator first indicator value to represent the available dictionary; and
computer code for transmitting the first indicator value of the second indicator to represent the available dictionary.

37. A computer program product arranged to perform a method for decompressing data as claimed in claim 36, further comprising
computer code for determining an available decompression algorithm;
computer code for selecting a second indicator second indicator value to represent the available decompression algorithm; and
computer code for transmitting the second indicator value of the second indicator to represent the available decompression algorithm.
